(19) United States
(12) Patent Application Publication
(10) Pub. No.: US 2009/0200351 A1
(43) Pub. Date: Aug. 13, 2009

(54) TRUCK TOOL BOX AND HINGE SYSTEM

(76) Inventors: Steven Dale Brallier, Rogersville, MO (US); Brian Gene Sharp, Rogersville, MO (US); Jason Dale Hutchens, Springfield, MO (US); James Gerard Quintus, Springfield, MO (US)

Correspondence Address: KANG INTELLECTUAL PROPERTY LAW, LLC, 214 ELM STREET, SUITE 106, WASHINGTON, MO, 63090, US

(21) Appl. No.: 12/354,330

(22) Filed: Jan. 15, 2009

Related U.S. Application Data
(63) Continuation-in-part of application No. 12/069,060, filed on Feb. 7, 2008.

(51) Int. Cl. B60R 9/00; F16M 11/00

(52) U.S. Cl. 224/404; 248/200

(57) ABSTRACT

The invention is a truck tool box that is attached to the bed of a pickup truck. The tool box is attached using brackets, a hinge system, and a latch system that allows a user to unlatch tile tool box and swing it to the user. A separate universal latch mount bracket for an installation of a latch allows greater variations in the placement of the latch mount bracket, while enabling the latch to be aligned with the mating latch disposed on the tool box.

### CROSS-REFERENCE TO RELATED APPLICATIONS

This application is a continuation-in-part of application Ser. No. 12/069,060 filed Feb. 7, 2008.

### STATEMENT REGARDING FEDERALLY SPONSORED RESEARCH

Not Applicable.

### APPENDIX

Not Applicable.

### BACKGROUND OF THE INVENTION

1. Field of The Invention

The present invention relates to tool boxes and, more specifically, to a tool box that can be pivotably mounted to a bed of a truck and a latch system for use with the tool box.

2. RELATED ART

Prior tool boxes have been mounted to a bed of a truck. Some tool boxes have often been extremely large, and consequently have removed a great deal of usable space from the bed area. Other tool boxes are located in a position that makes access extremely difficult. Yet other tool boxes are fixed in a single position.

All of the known tool boxes that are mounted in a bed of a truck have advantages and disadvantages, but there is a need in the art to provide maximize usable space, and still provide ease of access.

### SUMMARY OF THE INVENTION

The invention is a truck tool box that is mounted in a bed of a truck. In a preferred embodiment, the tool box is mounted using a truck bracket, and a first and second mating hinge members connecting the tool box to the truck bracket. There is preferably provided a box plate for attaching the first mating hinge member. The tool box is preferably adapted to the shape of the wheel well of the truck, and is further adapted to provide clearance with the bed of the truck to permit a swinging (pivoting) action of the tool box.

The first mating hinge member may be male and the second hinge member may be female. Alternatively, the first mating hinge member may be female, and the second mating hinge member may be male. Further alternatively, the first mating hinge member may be both male and female, with the second mating hinge member being oppositely female mid male.

There are a number of important innovations with the truck tool box itself. The first and second body portions of the truck tool box are each provided with an exterior seam. This seam provides structural rigidity and allows for ease of manufacturing. The lid of the truck tool box provides functionality bit exterior contouring, and a panel is bonded beneath the lid to provide structural rigidity.

A latching mechanism is provided on the exterior of the box, and which is actuated by a spring biased pull rod that runs along the bottom of the tool box. The mate for the latching mechanism may be provided on the truck bracket or on the truck. A small tray may be disposed in the shallow portion of the tool box for providing a light.

In an embodiment without a truck bracket, a female latch can be mounted on the truck bed through a separate universal latch mount bracket. Unlike the truck bracket, the universal latch mount is not connected to the hinge bracket. As there is no part connecting the universal latch mount bracket to the hinge members or hinge mount bracket, the universal latch mount can be freely installed on the truck bed at an arbitrary distance from the hinge area.

The universal latch mount bracket has a latch mount portion for an installation of the female latch and a flange portion for an attachment to the truck bed. The location of the female latch on the latch mount bracket portion is adjustable between a plurality of installation locations. Preferably, the latch mount portion has a slot that provides the installation locations of the female latch so that the location of the female latch on the latch mount bracket is adjustable along the length of the slot. The slot preferably extends horizontally so that the location of the female latch is adjustable in a horizontal direction. The universal latch mount bracket preferably has a channel on its rear surface facing toward the truck bed so that the universal mount bracket can be installed even in the area where there are protrusions. The channel is preferably a vertically extending channel as the side walls of truck bed usually have vertical protrusions.

It is also important to the invention to control the dimension of the hinge pivot area to ensure proper swinging action of the tool box. Accordingly, the hinge pivot area is defined on one side as two inches plus the distance between the lightwell to the bed side, and defined on the other side as five inches from the tailgate forward.

Further areas of applicability of the present invention will become apparent from the detailed description provided hereinafter. It should be understood that the detailed description and specific examples, while indicating the preferred embodiment of the inventions are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1. is an elevated view of an embodiment of the truck tool box according to the present invention installed in a truck bed in a latched position;

FIG. 2 is an elevated view of the embodiment of the truck tool box of FIG. 1, wherein the tool box is in a non-latched position;

FIG. 3 is a left side view of an embodiment of the truck tool box according to the present invention;

FIG. 4 is a right side view of the embodiment of the truck tool box of FIG. 3;

FIG. 5 is a rear view of the embodiment of the truck tool box of FIG. 3;

FIG. 6 is a bottom view of the embodiment of the truck tool box of FIG. 3;

FIG. 7 is a top plan view of the embodiment of the truck tool box of FIG. 3;

FIG. 8A is a bottom elevated view of the bottom portion of an embodiment of the truck tool box according to the present invention, wherein the hinge system is attached at the rear of the truck tool box;

FIG. 8B is a bottom elevated view of the bottom portion of an alternative embodiment of the truck tool box according to the present invention, wherein the hinge system is attached at the side of the truck tool box, and wherein a Bowden cable is used instead of a rod as a longitudinal member;

FIG. 9 is a rear elevated assembly view of an embodiment of the truck tool box according to the present invention wherein the male hinge pins are disposed on the truck bracket:

FIG. 10 is a rear elevated assembly view of an alternative embodiment of the truck tool box according to the present invention wherein the male and female hinge members are equally shared between the truck bracket and the box bracket;

FIG. 11 is a rear elevated assembly view of another alternative embodiment of the truck tool box according to the present invention wherein the male hinge pins are disposed on the box bracket;

FIG. 12 is a rear elevated assembly view of an embodiment of the truck tool box according to the present invention;

FIG. 13 is a rear elevated assembly view of an alternative embodiment of the truck tool box according to the present invention;

FIG. 14 is a partial top plan view showing a hinge pivot area in a truck bed for the truck tool box according to the present invention;

FIG. 15 is a partial top plan view of an embodiment of the truck tool box according to the present invention installed in a hinge pivot area in a truck bed, wherein the tool box is in a latched position;

FIG. 16 is a partial top plan view of the embodiment of the truck tool box of FIG. 15 wherein the tool box is in an unlatched position;

FIG. 17 is a partial elevated view of an embodiment of the truck tool box according to the present invention, wherein the tool box is in an unlatched position, and wherein the female latch portion is disposed on the truck bracket;

FIG. 18 is a partial elevated view of an alternative embodiment of the truck tool box according to the present invention, wherein the tool box is in an unlatched position, and wherein a female latch is mounted on a universal latch mount bracket installed over a protrusion on the side wall of the truck bed;

FIG. 19 is a partial elevated view of the embodiment of the truck tool box of FIG. 18, wherein the tool box is in an unlatched position, and wherein the universal latch mount bracket is installed in a different location on the side wall of the truck bed;

FIG. 20 is a partial elevated view of the embodiment of the truck tool box of FIG. 19 in a latched position;

FIG. 21 is an elevated front exploded view of the universal latch mount bracket and the female latch shown in FIG. 18; and

FIG. 22 is an elevated rear view of the universal latch mount bracket and the female latch of FIG. 21, assembled with each other.

### DETAILED DESCRIPTION OF THE PREFERRED EMBODIMENTS

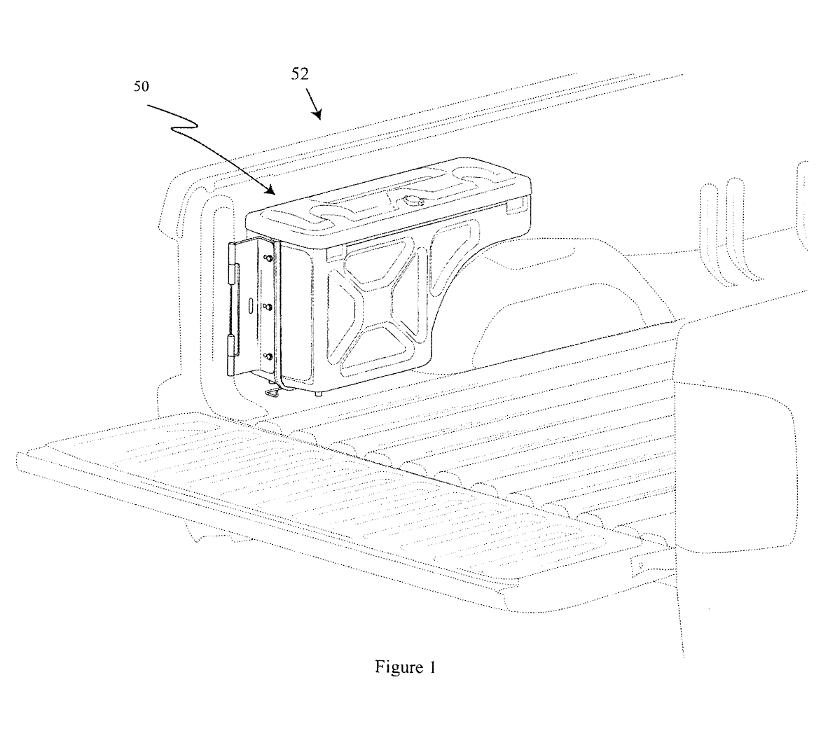

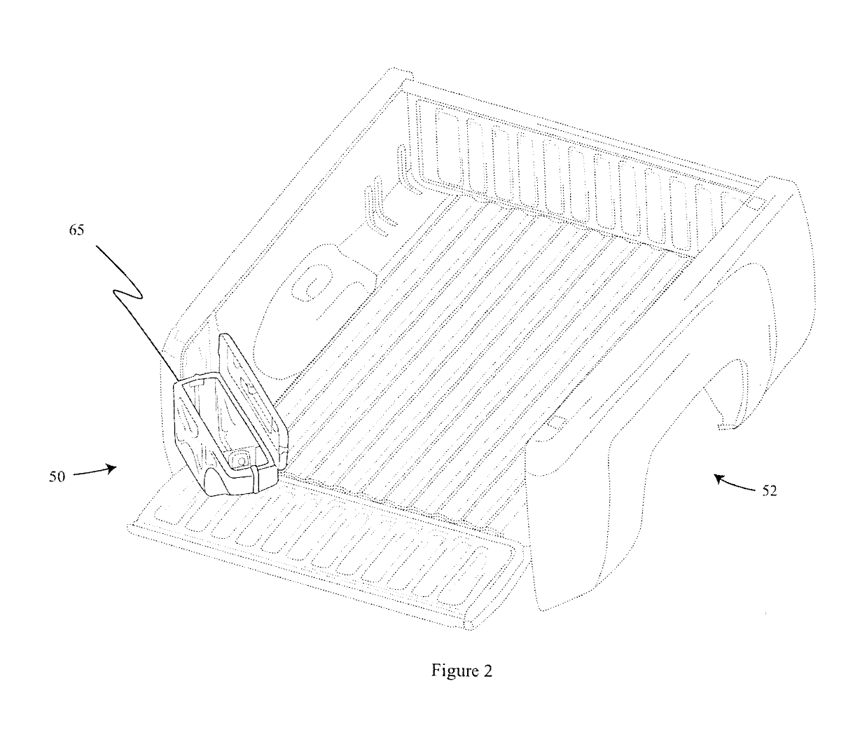

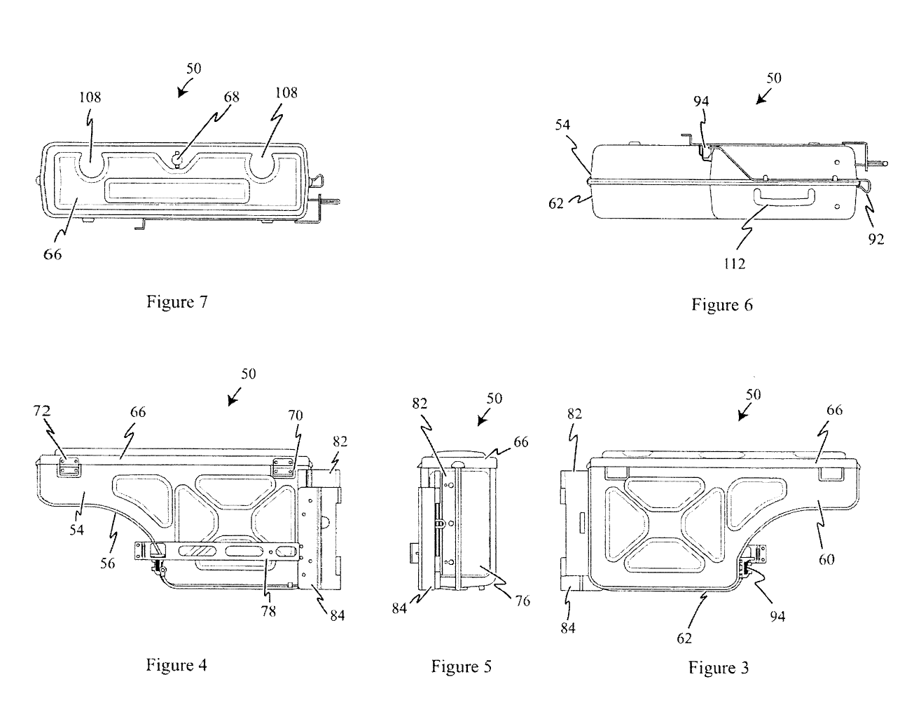

The following description of the preferred embodiment(s) is merely exemplary in nature and is in no war intended to limit the invention, its application, or uses. As shown in the drawings, according to FIGS. 1-13, there is shown a truck toolbox, generally at 50 installed in a bed, generally at 52, of a truck. FIG. 1 shows a tool box 50 in a latched position, and FIG. 2 shows the tool box 50 in an unlatched position.

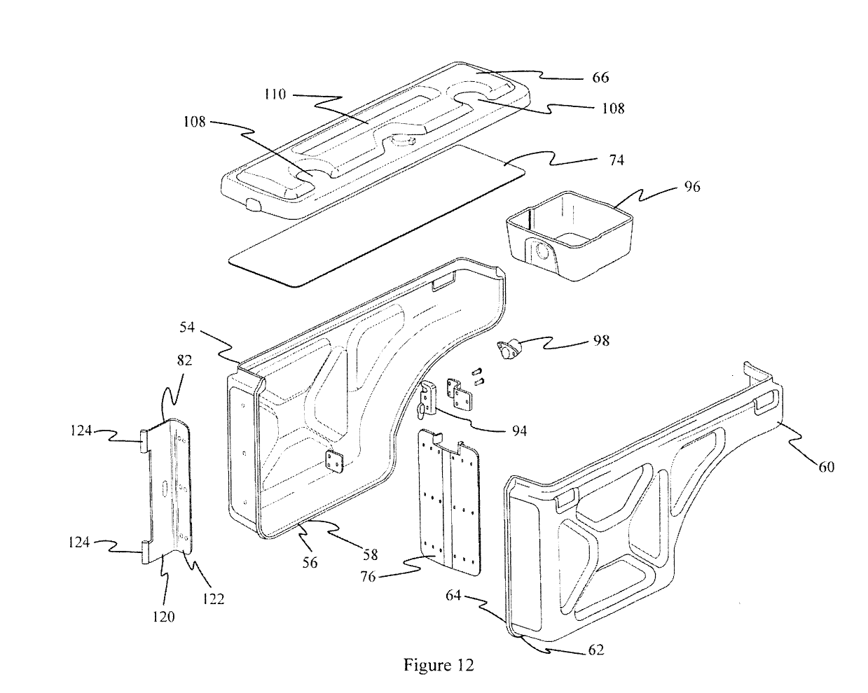

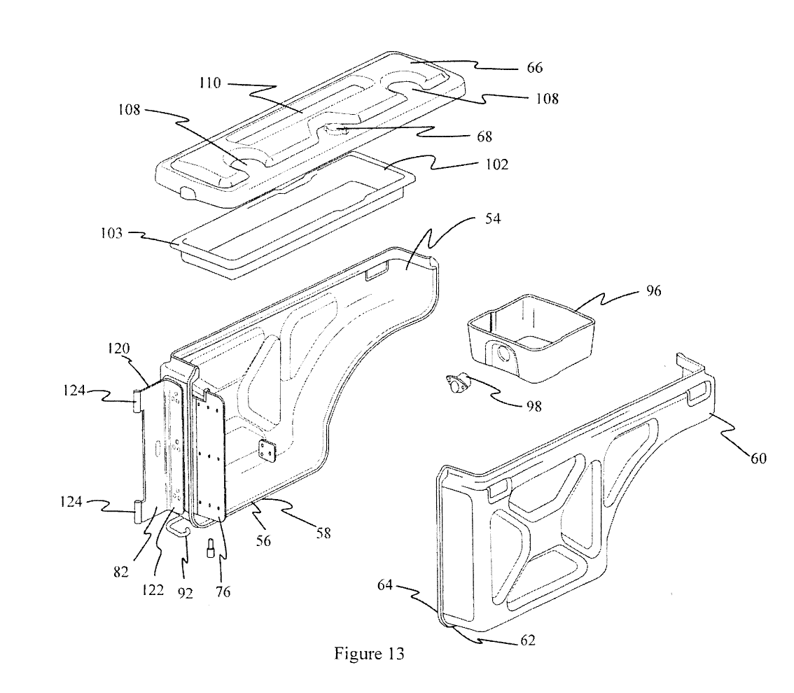

The truck tool box 50 has a first body portion 54 shown with a first exterior seam 56, having a first rectangular area 58. Similarly, the truck tool box 50 has a second body portion 60 with a second exterior seam 62, having a second rectangular area 64. As best shown in FIG. 12 and FIG. 13, the first rectangular area 58 of the first exterior seam 56 of the first body portion 54 is joined with the second rectangular area 64 of the second exterior seam 62 of the second body portion 60. Thus joined, the first body portion 54 and the second body portion 60 defines an interior space 65.

The truck tool box 50 is also provided with a lid 66. A lock 68 is provided on the lid 66. The lid 66 is joined to the first body portion 54 via a first lid hinge member 70 and a second lid hinge member 72. Preferably, the lid 66 is reinforced by a lid panel 74 which provides structural rigidity and integrity. The lid 66 is also provided with a cup holder recess 108 and a rectangular recess 110 for depositing small objects such as screws, nails, or nuts.

The joinder of the first body portion 54, the second body portion 60, and the lid 66 form the basic tool box 50. As shown in the drawings, the joinder of these elements provide the tool box 50 having a front, a rear, a right side, a left side, a top, and a bottom. At the rear of the tool box 50, a box plate is preferably attached. To the bed 52 of the truck, a truck bracket 78 is attached. Then, between the box plate 76 and the truck bracket 78 is placed a first mating hinge member 82, alternatively referred to as “L-shaped box bracket,” and a second hinge mating member 84. As shown more specifically in FIG. 9-11, male pins 86 may be disposed on the second hinge mating member 84, or alternatively on each of the L-shaped box bracket 82 and the second hinge mating member 84, or alternatively on the L-shaped box bracket 82 alone.

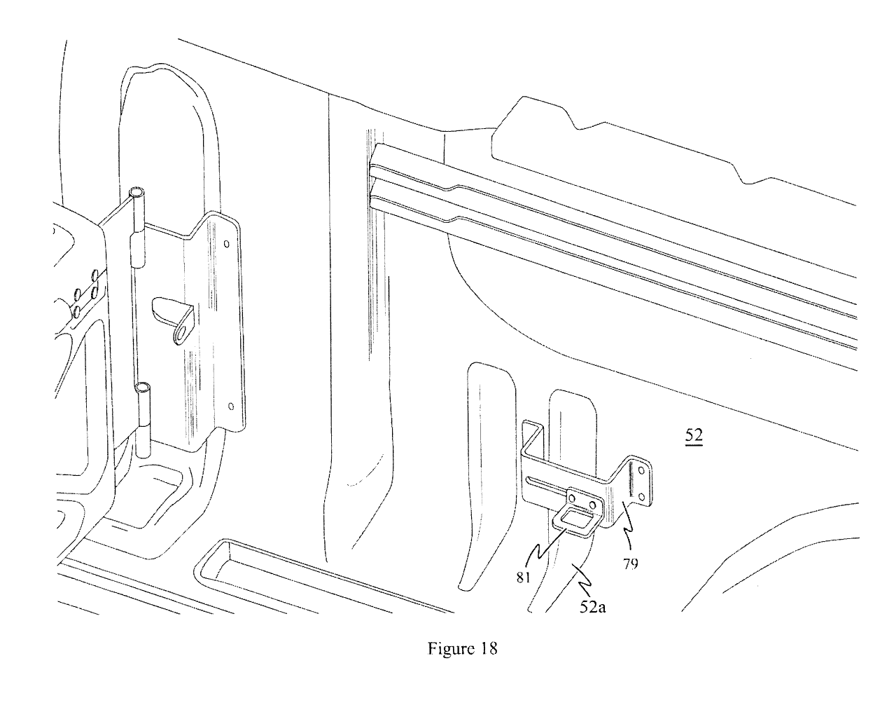

Thus, attached to the bed 52 of the pickup truck, the tool box 50 may assume a latched or unlatched position. To accomplish this, a spring-biased male latch portion 94 is disposed on the front of truck tool box 50, and a female latch portion 80 may be disposed on the truck bracket 78. In an alternative embodiment, the female latch portion 80 may be separately disposed on the bed 52 of the pickup truck as will be explained below in details with reference to FIGS. 18-22. A longitudinal member 92, alternatively referred to as a rod 92 or as a Bowden cable, is disposed along the bottom of truck tool box 50. At one end, the rod 92 pulls the spring-biased male latch portion 94 to release it from the female latch portion 80. The other end of the rod 92 extends beyond the rear plane of the tool box 50 in an ergonomic accessible manner, preferably a hook shape. The spring-biased male latch portion 94 is adapted to close with the female latch portion 80 upon the application of sufficient force.

It will be appreciated that the L-shaped box bracket 82 has a first body portion 120 and a second body portion 122. The second body portion 122 of the L-shaped box bracket 82 is adapted for attachment to the truck tool box 50 while the first body portion 120 has a first mating hinge connector 124. The second mating hinge connector 84 has a first body portion 126 attached to the truck bracket 78, a second body portion 128 disposed at an angle to the first body portion 126, and a third body portion 130 disposed at an angle to the second body portion 128. The third body portion 130 of the second hinge mating member 84 is adapted to mate with the first mating hinge connector 124 of the L-shaped box bracket 82.

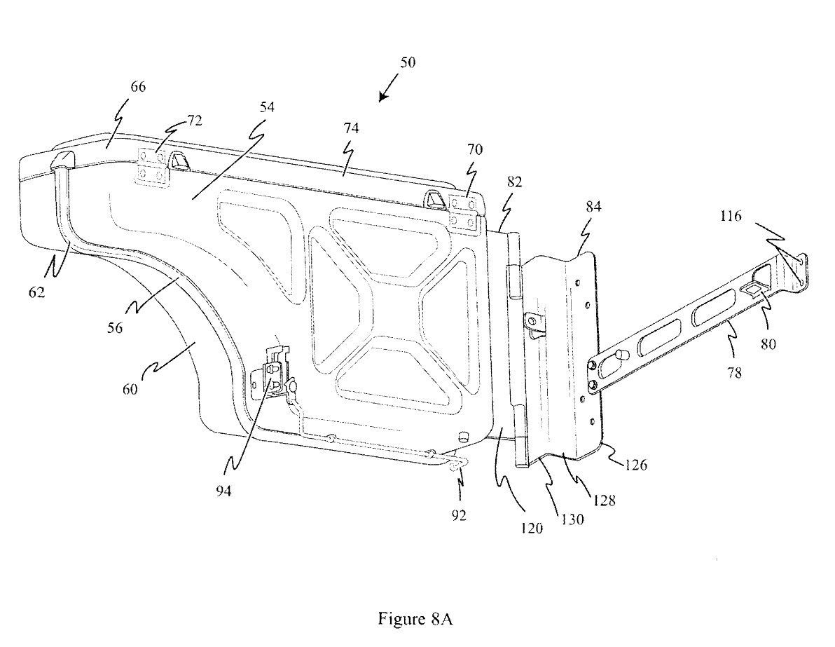

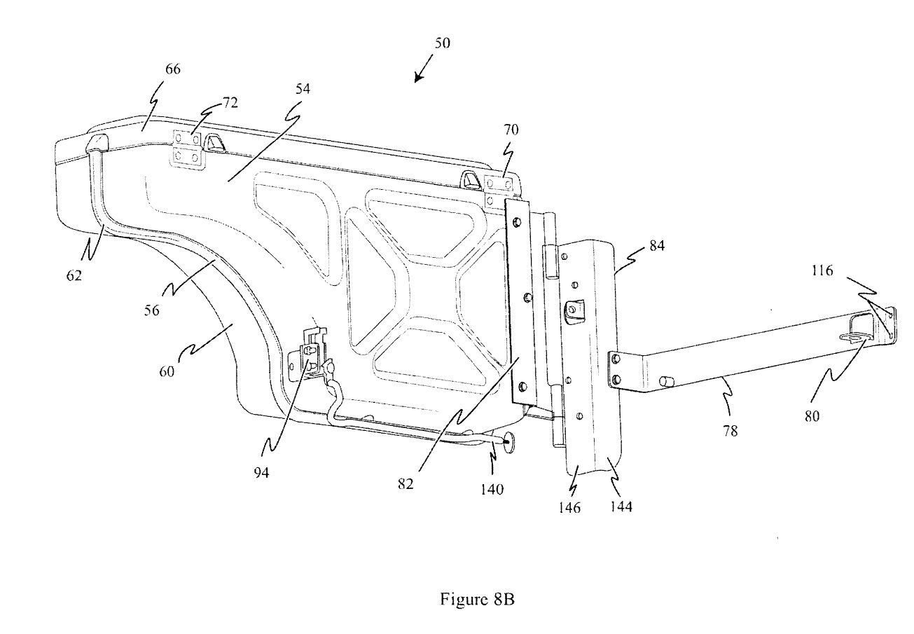

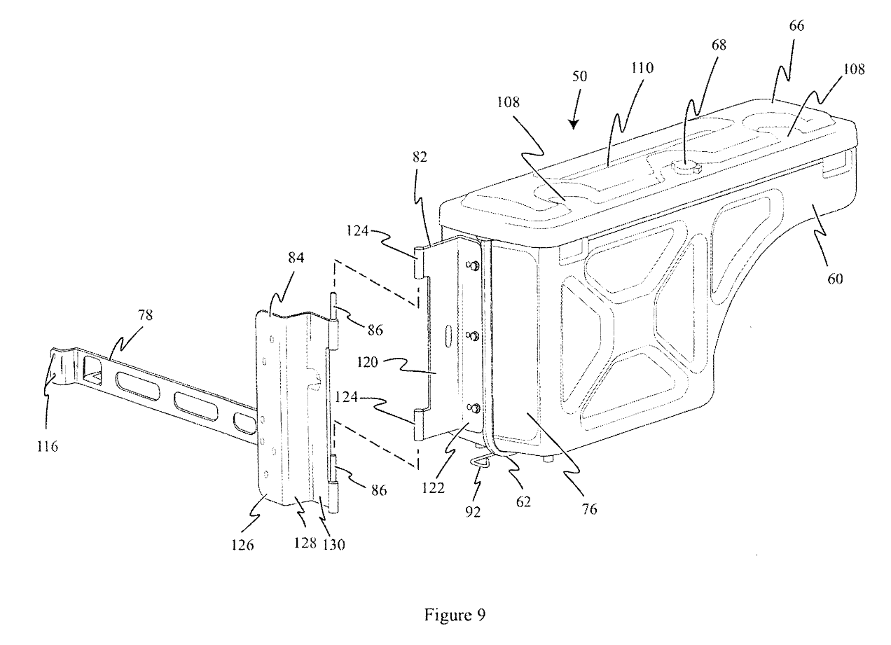

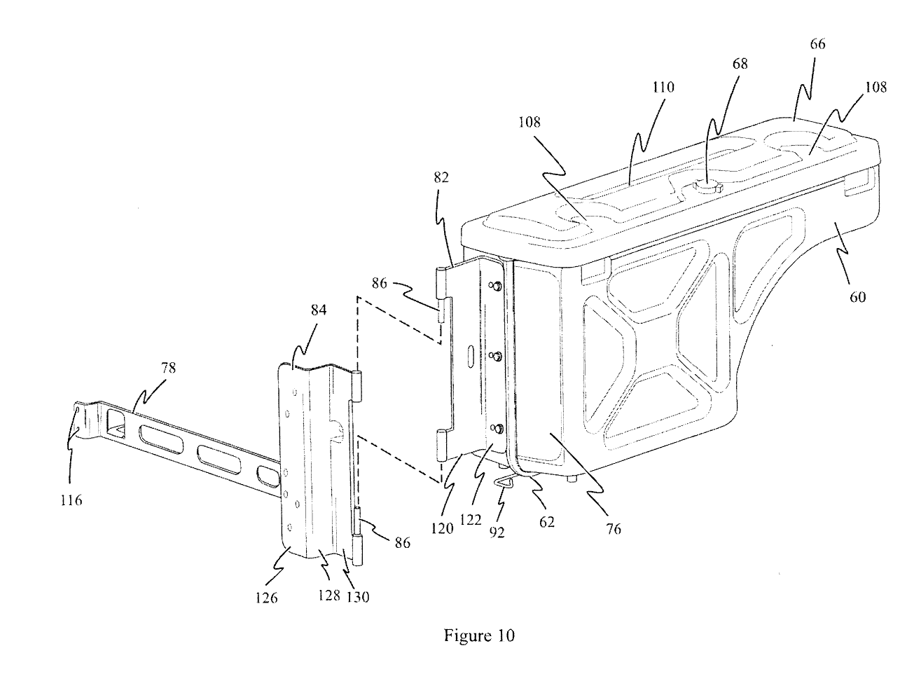

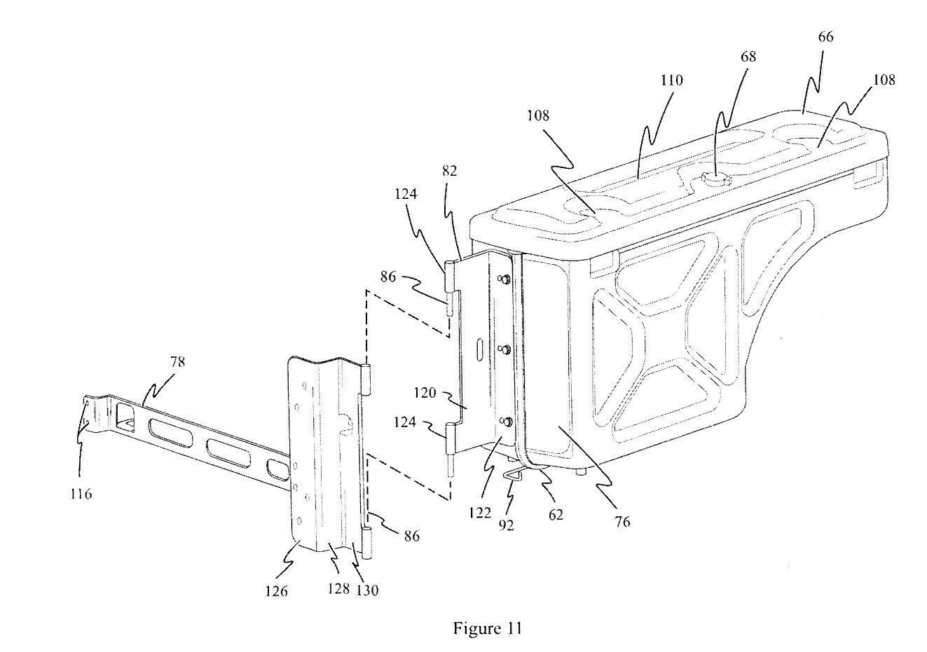

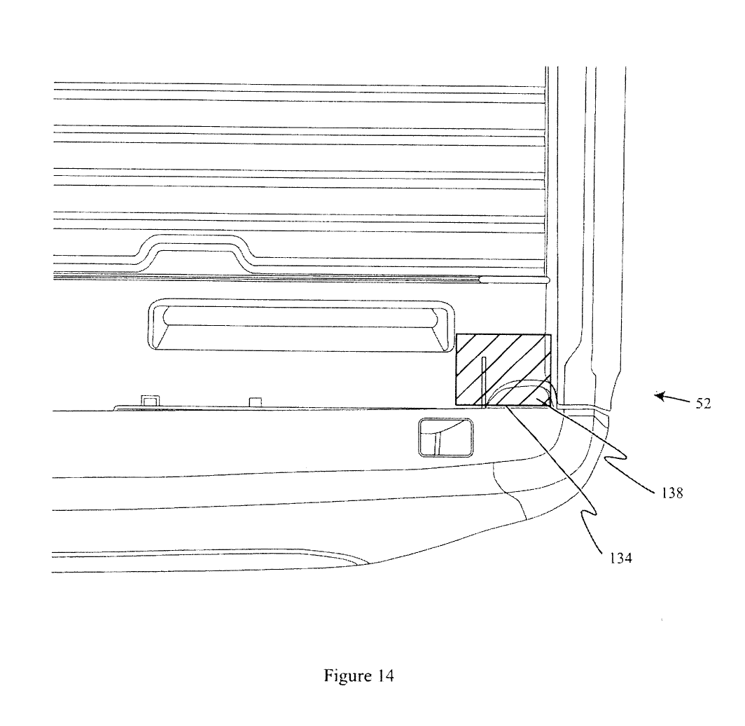

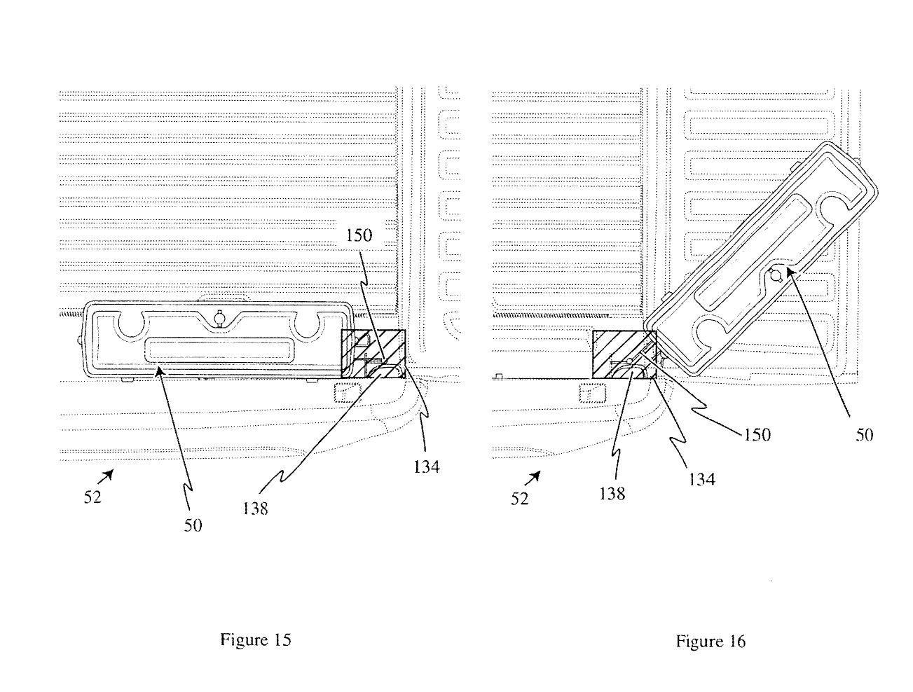

The geometric details regarding the L-shaped box bracket 82 and the second hinge mating member 84 are important because the hinge and swinging action of the truck tool box 50 will not be successful unless sufficient clearance is provided from the lightwell 138 at the rear of the bed 52. In order to have sufficient clearance from the lightwell 138, there is defined a hinge pivot area 134 as best shown in FIGS. 14, 15 and 16. It is critical to the operability and utility of the invention that the hinge pivot point 150 be located in the area defined by the hinge pivot area 134. The hinge pivot point is the point where the second mating hinge connector 84 mates with the first mating hinge connector 124 of the box bracket 82. In particular, this hinge pivot area 134 is defined on one side as the dimension of five inches along the inside sidewall of the truck bed 52 from the tailgate edge forward to the cab, and on the other side as the dimension of two inches from the outer edge of the lightwell 138 measured away from the nearest truck bed inside sidewall, minus the area occupied by the lightwell 138 itself. As clearly seen in FIGS. 15 and 16, the hinge pivot point 150 in the present invention must be located within the hinge pivot area 134 in order to have an appropriate swing action, for convenience of unlatching, and to avoid damaging the lightwell 138. Accordingly, as seen in FIG. 8A, both the L-shaped box bracket 82 and the second mating hinge connector 84, and their respective body portions, 120, 122, 126, 128, 130, respectively, are specifically adapted and dimensioned such that the hinge pivot point 150 is located within the hinge pivot area 134, which provides clearance from lightwell 138. In an alternative embodiment shown in FIG. 8B, both the box bracket 82 and the second mating hinge connector 84 are likewise adjusted in the various dimensions of body portions 144 and 146 in order to place the hinge pivot point 150 within the hinge pivot area 134, and guaranteeing that there will be no interference in movement of the hinge system or from the truck tool box 50 with lightwell 138.

In the alternative embodiment of FIG. 8B, there is shown a longitudinal member 144, alternatively referred to as a Bowden cable 144. The Bowden cable 144 may be used instead of the rod 92 as a different longitudinal member 144. In addition, it can be seen in this alternative embodiment that the second mating hinge member 84 can have only two body portions, a first body portion 144 and a second body portion 146. More importantly, it can be seen that the box bracket 82 is not L-shaped as in the embodiment of FIG. 8A and is attached to the side of truck tool box 50, instead of being attached at the rear of truck tool box 50 (shown in the primary embodiment of FIG. 8A).

A tray 96 may be bonded within the interior space 65 of truck tool box 50. This tray 96 is preferably provided with a light 98. In an alternative embodiment, a removable tray 102 may further be provided. Such removable tray has a lip 103 disposed in circumference and which rests on contours provided within the interior space 65.

In operation the truck tool box 50 assumes the position of FIG. 1, a latched position. A user inserts his or her finger into the hook provided in the rod 92 and pulls it. Pulling the rod 92 longitudinally releases the spring-biased male latch portion 94 from the female latch portion 80, and the tool box swings according to the L-shaped box bracket 82 and the second hinge mating member 84 towards the user. Importantly, because the hinge pivot point 150 is located within the hinge pivot area 134, the truck tool box 50 swings without any touching of the lightwell 138 by either the truck tool box 50 or the hinge system. Then the user may open the lid 66 and access the interior space 65, as shown in FIG. 2. Should the user need to take the truck tool box 50 out of the bed 52 of the truck, the user may lift the tool box 50 (best shown in FIG. 9) and carry the truck tool box 50. For convenience, a handle 112 is provided (FIG. 6).

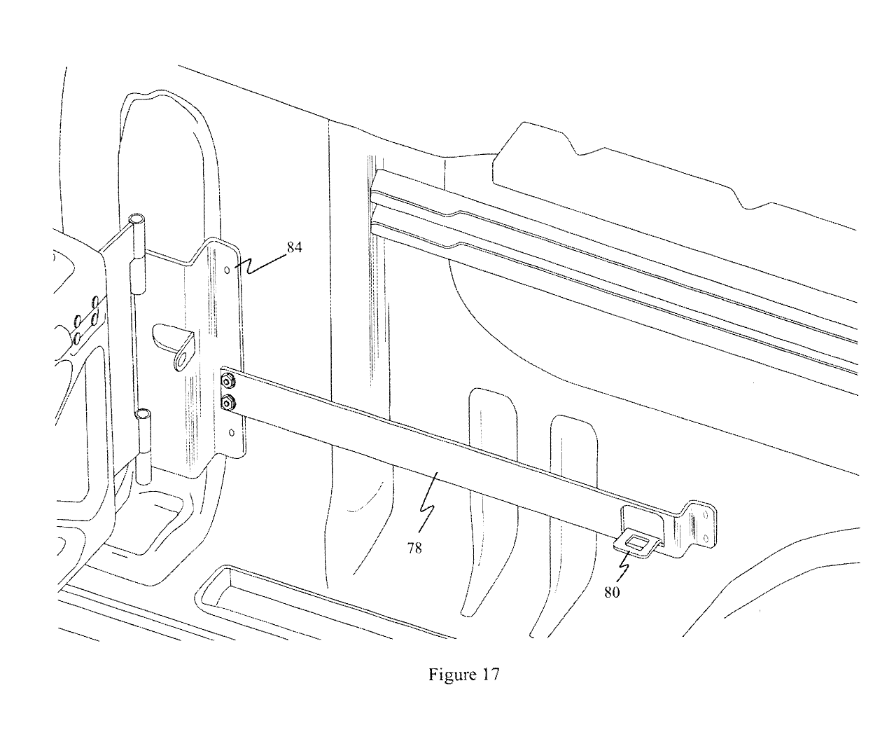

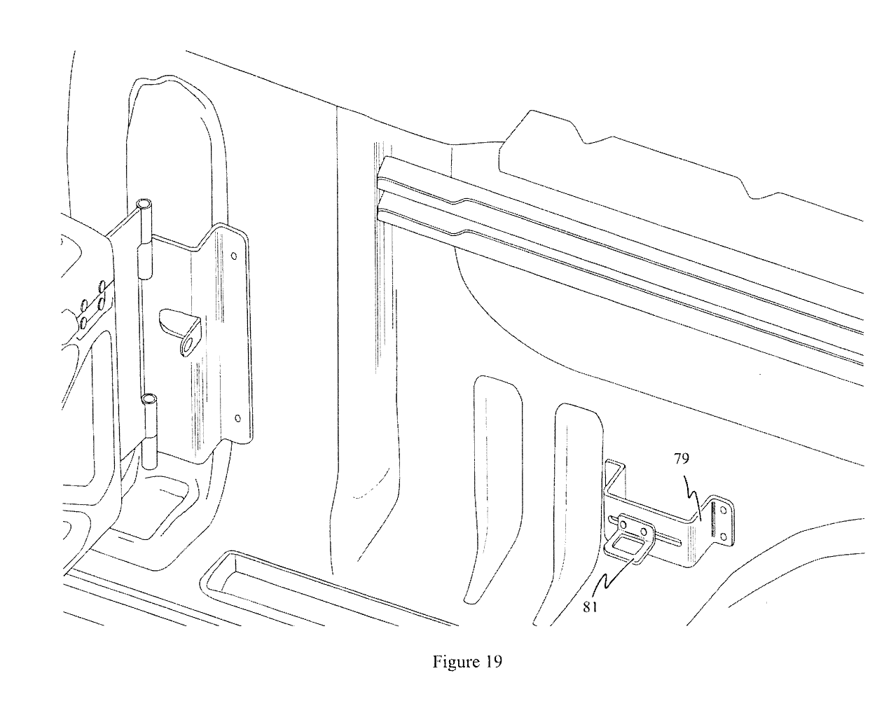

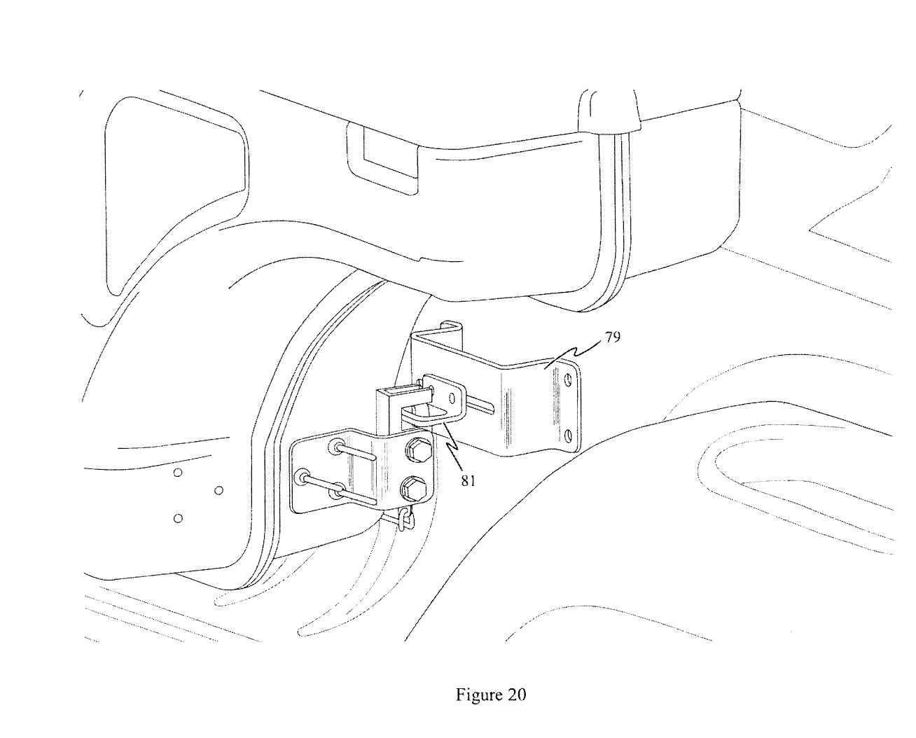

In an embodiment as shown in FIG. 17, the female latch portion 80 can be disposed on the truck bracket 78 which is attached to the truck bed 52 and also to the second hinge mating member 84. In all alternative embodiment as shown in FIG. 18, the truck bracket 78 is omitted. Instead, a female latch 81 is mounted on a universal latch mount bracket 79 which is attached to the truck bed 52 but not to the second hinge mating member 84. As the universal latch mount bracket 79 is separate from, and not connected to, the second hinge mating member 84, the universal latch mount bracket 79 can be installed in variant locations in the truck bed 52. FIG. 18 and FIGS. 19 and 20 show the universal latch mount bracket 79 installed in different locations in the truck bed 52. In FIG. 18, the universal latch mount bracket 79 is installed in the truck bed 52 over a protrusion 52a. In FIGS. 19 and 20, the universal latch mount bracket 79 is installed in the truck bed 52 on a flat surface.

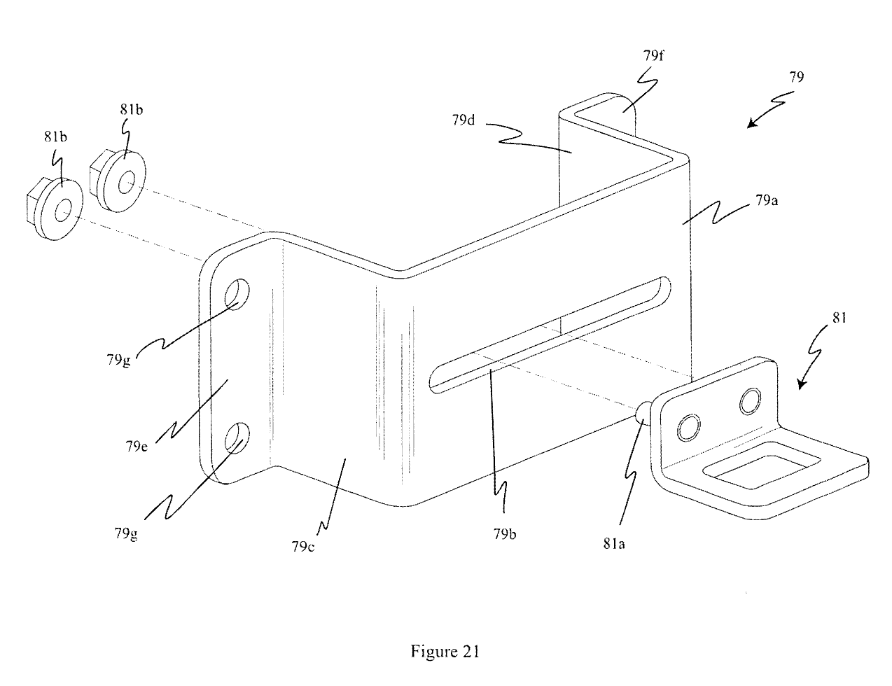

FIG. 21 shows in details the universal latch mount bracket 79 and the female latch 81. The universal latch mount bracket 79 has a latch mount plane 79a. The latch mount plane 79a has a horizontally extending slot 79b which provides mount for the female latch 81. As the female latch 81 can be mounted at any desired location along the length of the slot 79b, the location of the female latch 81 in relation to the universal latch mount bracket 79 is horizontally adjustable.

The universal latch mount bracket 79 also has two flange portions 79e, 79f for attachment onto the truck bed 52. The two flange portions 79e, 79f are in the same plane, which is parallel with the latch mount plane 79a. The flange portions 79e, 79f each has two screw holes 79g for use in screw fastening of the universal latch mount bracket 79 onto the truck bed 52. A different number of screw holes, or even other means of attachment than screw fastening, can also be employed.

The universal latch mount bracket 79 also has two side walls 79c, 79d between the latch mount plane 79a and the two flange portions 79e, 79f, respectively. The two side walls 79c, 79d are perpendicular to the latch mount plane 79a and to the two flange portions 79e, 79f. Accordingly, there is a channel defined by inner surfaces the two side walls 79c, 79d and the latch mount plane 79a. This configuration enables the universal latch mount bracket 79 to be installed in a non-flat surface area having protrusions 52a or recesses of the truck bed 52, as shown in FIG. 18, as well as in a flat surface area of the truck bed 52, as shown in FIGS. 19 and 20.

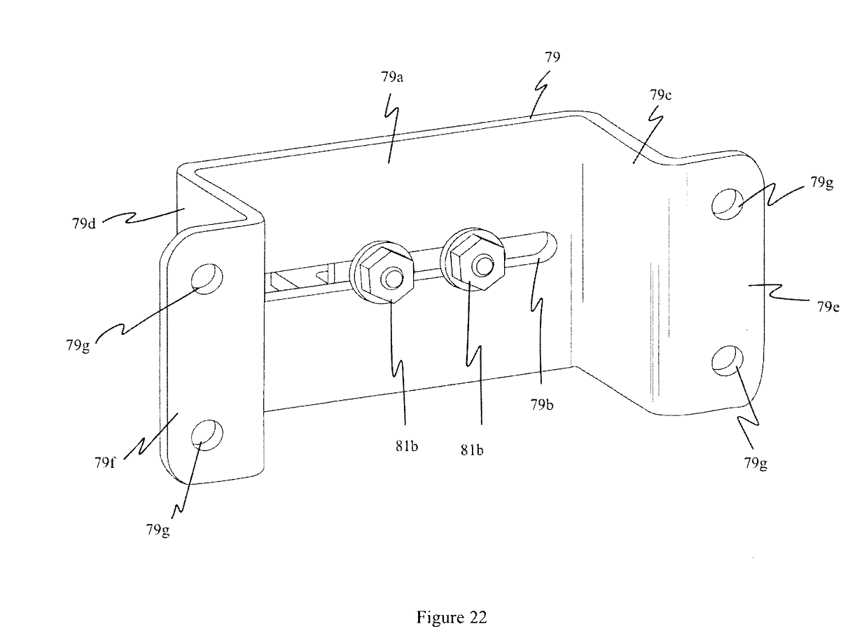

The female latch 81 has two protruding screw portions 81a for its attachment to the universal latch mount bracket 79. The female latch 81 can be attached to the universal latch mount bracket 79 by first inserting the protruding screw portions 81a through the slot 79a of the universal latch mount bracket 79 and then engaging bolts 81b with the protruding screw portions 81a, as shown in FIG. 22. Other fastening means than screw and bolt fastener can also be employed for the attachment of the female latch 81 to the universal latch mount bracket 79.

The advantages of the configurations of the universal latch mount bracket 79 include its huge range of applications. Not only can the universal latch mount bracket 79 be installed in variant locations in the truck bed 52, but the location of the female latch 81 on the universal latch mount bracket 79 can also be adjustable between variant locations along the length of the slot 79a. The combination of these two configurations allows greater variations in the placement of the universal latch mount bracket 79, while enabling the female latch 81 to be aligned with the spring-biased male latch portion 94. In addition, the universal latch mount bracket 79 is much smaller than the truck bracket 78.

As various modifications could be made to the exemplar embodiments, as described above with reference to the corresponding illustrations, without departing from the scope of the invention, it is intended that all matter contained in the foregoing description and shown in the accompanying drawings shall be interpreted as illustrative rather than limiting. For example, it is understood that the various body portions 54, 60 may be made in a variety of shapes and colors for aesthetics. In addition, the lid 66 may be provided with a translucent top and be made to glow via light provided on the other body side. Additional magnetic pads, not shown, may be introduced in order to facilitate storage of tools or hardware. Thus, the breadth and scope of the present invention should not be limited by any of the above-described exemplary embodiments, but should be defined only in accordance with the following claims appended hereto and their equivalents.

What is claimed is:

1. A truck tool box comprising:
a tool receiving portion defining an interior space for receiving tools therein; and
a hinge member for removably and pivotably connecting said tool receiving portion to a truck bed.

2. A truck tool box system comprising:
a tool receiving portion defining an interior space for receiving tools therein;
a hinge mount bracket disposed on a truck bed; and
a hinge member for removably and pivotably connecting said tool receiving portion to said hinge mount bracket.

3. The truck tool box system of claim 2, further comprising:
a first latch disposed on said too; receiving portion; and
a second latch disposed on the truck bed, wherein said second latch is removeably engageable with said first latch.

4. The truck tool box system of claim 3, further comprising:
a latch mount bracket disposed on the truck bed for an installation of said second latch onto the truck bed.

5. A truck tool box system comprising:
a tool receiving member defining an interior space for receiving tools therein;
a hinge mount bracket disposed on a truck bed;
a hinge member fixedly attached to said tool receiving member, said hinge member pivotably connecting said tool receiving member to said hinge mount bracket;
a first latch disposed on said tool receiving member;
a universal latch mount bracket installed in the truck bed; and
a second latch disposed on said universal latch mount bracket, said second latch being removeably engageable with said first latch;
wherein said universal latch mount bracket is separate from said hinge mount bracket.

6. The truck tool box system of claim 5, wherein said universal latch mount bracket has a latch mount portion for an installation of said second latch and a flange portion for an installation onto the truck bed.

7. The truck tool box system of claim 6, wherein said latch mount portion provides a plurality of installation locations for said second latch such that the location of said second latch relative to said universal latch mount bracket is adjustable between said plurality of installation locations.

8. The truck tool box system of claim 6, wherein said latch mount portion has an extending latch mount for the installation of said second latch such that the location of said second latch relative to said universal latch mount bracket is adjustable along the extent of said extending latch mount.

9. The truck tool box system of claim 8, wherein said extending latch mount comprises a slot that extends horizontally.

10. The truck tool box system of claimed, wherein said universal latch mount bracket has a rear surface facing toward the truck bed, said rear surface having a concave portion.

11. The truck tool box system of claim 10, wherein said concave portion comprises a channel that extends vertically.

12. A universal mount bracket comprising:
a mount portion for an installation of a latch; and
a flange portion for an attachment to a truck bed;
wherein said mount portion provides a plurality of installation locations for the latch such that the location of the latch relative to said universal mount bracket is adjustable between said plurality of installation locations.

13. The universal mount bracket of claim 12, wherein said mount portion has an extending mount for the installation of the latch such that the location of the latch relative to said universal mount bracket is adjustable along the extent of said extending mount.

14. The universal mount bracket of claim 13, wherein said extending mount comprises a slot that extends horizontally.

15. The universal mount bracket of claim 12, wherein said latch mount bracket has a rear surface facing toward the truck bed, said rear surface having a concave portion.

16. The universal mount bracket of claim 15, wherein said concave portion comprises a channel that extends vertically.

17. A mount bracket and latch assembly comprising:
a universal mount bracket; and
a latch attached to said universal mount bracket;
wherein said universal mount bracket comprises a latch mount portion for an installation of said latch, and a flange portion for an attachment onto a truck bed; and
wherein said latch mount portion provides a plurality of installation locations for said latch such that the location of said latch is adjustable between said plurality of installation locations.

18. The mount bracket and latch assembly of claim 17, wherein said latch mount portion has an extending mount for the installation of said latch such that the location of said latch relative to said universal mount bracket is adjustable along the extent of said extending mount.

19. The mount bracket and latch assembly of claim 18, wherein said extending mount comprises a slot that extends horizontally.

20. A latch system comprising:
a first latch disposed on a tool box, the tool box pivotably connected to a hinge mount bracket attached onto a truck bed;
a second latch removably engageable with said first latch; and
a latch mount bracket having a latch mount portion for an installation of said second latch and a flange portion for an attachment onto the truck bed;
wherein said latch mount bracket is separate from the hinge mount bracket.

21. The latch system of claim 20, wherein said latch mount portion provides a plurality of installation locations for said second latch such that the location of said second latch relative to said latch mount bracket is adjustable between said plurality of installation locations.

22. The latch system of claim 21, wherein said latch mount portion has an extending latch mount for the installation of said second latch such that the location of said second latch relative to said latch mount bracket is adjustable along the extent of said extending mount.

23. The latch system of claim 22, wherein said extending mount comprises a slot that extends horizontally.

24. The latch system of claim 22, wherein said latch mount bracket has a rear Surface facing toward the truck bed, said rear surface having a concave portion.

25. The latch system of claim 24, wherein said concave portion comprises a channel that extends vertically.

26. The latch system of claim 20, wherein said first latch comprises a male latch and said second latch comprises a female latch.

27. The latch system of claim 20, further comprising:
a latch release member for disengaging said first latch from said second latch.

28. The latch system of claim 27, wherein said latch release member comprises a Bowden cable.
